(19) United States
(12) Patent Application Publication
(10) Pub. No.: US 2026/0154636 A1
(43) Pub. Date: Jun. 4, 2026

(54) SYSTEM AND METHOD FOR GENERATING ENTERPRISE RESOURCE RECOMMENDATIONS

(71) Applicant: The Toronto-Dominion Bank, Toronto (CA)

(72) Inventors: Payal PAL, Toronto (CA); Arash Deljavan FARSHI, Richmond Hill (CA)

(73) Assignee: The Toronto-Dominion Bank, Toronto, ON (CA)

(21) Appl. No.: 18/968,292

(22) Filed: Dec. 4, 2024

(51) Int. Cl. G06Q 10/0631; G06F 3/04842; G06F 3/04847

(52) U.S. Cl. CPC G06Q 10/06315; G06F 3/04842; G06F 3/04847

(57) ABSTRACT

A server computer system comprises a communications module; at least one processor coupled with the communications module; and a memory coupled to the at least one processor and storing processor-executable instructions which, when executed by the at least one processor, configure the at least one processor to receive, via the communications module and from a computing device, a request for enterprise resource management recommendations; obtain input data for generating the enterprise resource management recommendations; engage an artificial intelligence engine to generate the enterprise resource management recommendations based on the input data, the artificial intelligence engine including an artificial intelligence model stack hosting a plurality of trained artificial intelligence models; receive, from the artificial intelligence engine, the enterprise resource management recommendations; and send, via the communications module and to the computing device, a signal causing the computing device to display the enterprise resource management recommendations on a graphical user interface that includes at least one adjustable interface element for adjusting at least one parameter of the input data and at least one selectable interface element for accepting at least one of the enterprise resource management recommendations.

### TECHNICAL FIELD

The present application relates to systems and methods for generating enterprise resource recommendations.

### BACKGROUND

Single-model recommendation engines, such as those using collaborative or content-based filtering, face significant limitations. For example, single-model recommendation engines often struggle with the cold-start problem (limited data for new users/items) and have restricted capacity to capture diverse preferences or adapt to evolving user behavior.

Further, single-model recommendation engines typically cannot dynamically adjust input data, limiting their ability to incorporate new data types that may improve relevance. This inflexibility reduces engagement, relevance and overall effectiveness.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 is a schematic diagram outlining various components of an artificial intelligence engine;

FIG. 4 shows, in flowchart form, an example method for generating enterprise resource management recommendations;

FIG. 5 is an example graphical user interface;

FIG. 6 is another example graphical user interface;

FIG. 7 shows, in flowchart form, an example method for generating updated enterprise resource management recommendations;

FIG. 8 is another example graphical user interface;

FIG. 9 is yet another example graphical user interface;

FIG. 10 shows, in flowchart form, an example method for updating a graphical user interface to display at least one parameter of the input data that is to be modified to achieve the resource contribution;

FIG. 11 is another example graphical user interface; and

FIG. 12 shows, in flowchart form, an example method for retraining at least one of the trained artificial intelligence models.

Like reference numerals are used in the drawings to denote like elements and features.

### DETAILED DESCRIPTION OF VARIOUS EMBODIMENTS

Accordingly, in one aspect there is provided a server computer system comprising a communications module; at least one processor coupled with the communications module; and a memory coupled to the at least one processor and storing processor-executable instructions which, when executed by the at least one processor, configure the at least one processor to receive, via the communications module and from a computing device, a request for enterprise resource management recommendations; obtain input data for generating the enterprise resource management recommendations; engage an artificial intelligence engine to generate the enterprise resource management recommendations based on the input data, the artificial intelligence engine including an artificial intelligence model stack hosting a plurality of trained artificial intelligence models; receive, from the artificial intelligence engine, the enterprise resource management recommendations; and send, via the communications module and to the computing device, a signal causing the computing device to display the enterprise resource management recommendations on a graphical user interface that includes at least one adjustable interface element for adjusting at least one parameter of the input data and at least one selectable interface element for accepting at least one of the enterprise resource management recommendations.

In one or more embodiments, the processor-executable instructions, when executed, further configure the at least one processor to receive, via the communications module and from the computing device, a signal indicating adjustment of the at least one adjustable interface element for adjusting the at least one parameter of the input data; obtain updated input data for generating updated enterprise resource management recommendations based on the adjustment of the at least one adjustable interface element; engage the artificial intelligence engine to generate updated enterprise resource management recommendations based on the updated input data; receive, from the artificial intelligence engine, the updated enterprise resource management recommendations; and send, via the communications module and to the computing device, a signal causing the computing device to update the graphical user interface to display the updated enterprise resource management recommendations.

In one or more embodiments, the enterprise resource management recommendations include at least one recommendation for a resource pool based on resource throughput extracted from the input data.

In one or more embodiments, the at least one recommendation for the resource pool defines a resource contribution for the resource pool.

In one or more embodiments, the graphical user interface displays the resource contribution for the resource pool and includes at least one adjustable interface element for adjusting the resource contribution to a particular value.

In one or more embodiments, the processor-executable instructions, when executed, further configure the at least one processor to receive, via the communications module and from the computing device, a signal indicating adjustment of the at least one adjustable interface element for adjusting the resource contribution to the particular value; engage the artificial intelligence engine to determine at least one parameter of the input data that is to be modified to cause the artificial intelligence engine to output the resource contribution to the particular value; and send, via the communications module and to the computing device, a signal causing the computing device to update the graphical user interface to display the at least one parameter of the input data that is to be modified.

In one or more embodiments, the processor-executable instructions, when executed, further configure the at least one processor to receive, via the communications module and from the computing device, a signal indicating selection of the selectable interface element to accept the at least one of the enterprise resource management recommendations; generate a set of training data that includes the input data and the accepted at least one of the enterprise resource management recommendations; and retrain at least one of the trained artificial intelligence models using the set of training data.

In one or more embodiments, the input data is retrieved from at least one of a database or an application programming interface (API) based at least on an identity of an enterprise.

In one or more embodiments, the plurality of trained artificial intelligence models employ a combination of collaborative filtering and reinforcement learning techniques.

In one or more embodiments, the plurality of trained artificial intelligence models are trained using training data that includes at least enterprise profile data, resource usage data, resource pool data, resource contribution data, resource throughput data, and feedback data.

According to another aspect there is provided a computer-implemented method comprising receiving, via a communications module and from a computing device, a request for enterprise resource management recommendations; obtaining input data for generating the enterprise resource management recommendations; engaging an artificial intelligence engine to generate the enterprise resource management recommendations based on the input data, the artificial intelligence engine including an artificial intelligence model stack hosting a plurality of trained artificial intelligence models; receiving, from the artificial intelligence engine, the enterprise resource management recommendations; and sending, via the communications module and to the computing device, a signal causing the computing device to display the enterprise resource management recommendations on a graphical user interface that includes at least one adjustable interface element for adjusting at least one parameter of the input data and at least one selectable interface element for accepting at least one of the enterprise resource management recommendations.

In one or more embodiments, the method further comprises receiving, via the communications module and from the computing device, a signal indicating adjustment of the at least one adjustable interface element for adjusting the at least one parameter of the input data; obtaining updated input data for generating updated enterprise resource management recommendations based on the adjustment of the at least one adjustable interface element; engaging the artificial intelligence engine to generate updated enterprise resource management recommendations based on the updated input data; receiving, from the artificial intelligence engine, the updated enterprise resource management recommendations; and sending, via the communications module and to the computing device, a signal causing the computing device to update the graphical user interface to display the updated enterprise resource management recommendations.

In one or more embodiments, the enterprise resource management recommendations include at least one recommendation for a resource pool based on resource throughput extracted from the input data.

In one or more embodiments, the at least one recommendation for the resource pool defines a resource contribution for the resource pool.

In one or more embodiments, the graphical user interface displays the resource contribution for the resource pool and includes at least one adjustable interface element for adjusting the resource contribution to a particular value.

In one or more embodiments, the method further comprises receiving, via the communications module and from the computing device, a signal indicating adjustment of the at least one adjustable interface element for adjusting the resource contribution to the particular value; engaging the artificial intelligence engine to determine at least one parameter of the input data that is to be modified to cause the artificial intelligence engine to output the resource contribution to the particular value; and sending, via the communications module and to the computing device, a signal causing the computing device to update the graphical user interface to display the at least one parameter of the input data that is to be modified.

In one or more embodiments, the method further comprises receiving, via the communications module and from the computing device, a signal indicating selection of the selectable interface element to accept the at least one of the enterprise resource management recommendations; generating a set of training data that includes the input data and the accepted at least one of the enterprise resource management recommendations; and retraining at least one of the trained artificial intelligence models using the set of training data.

In one or more embodiments, the input data is retrieved from at least one of a database or an application programming interface (API) based at least on an identity of an enterprise.

In one or more embodiments, the plurality of trained artificial intelligence models employ a combination of collaborative filtering and reinforcement learning techniques.

According to another aspect there is provided a non-transitory computer readable storage medium comprising computer-executable instructions which, when executed, configure a processor to receive, via a communications module and from a computing device, a request for enterprise resource management recommendations; obtain input data for generating the enterprise resource management recommendations; engage an artificial intelligence engine to generate the enterprise resource management recommendations based on the input data, the artificial intelligence engine including an artificial intelligence model stack hosting a plurality of trained artificial intelligence models; receive, from the artificial intelligence engine, the enterprise resource management recommendations; and send, via the communications module and to the computing device, a signal causing the computing device to display the enterprise resource management recommendations on a graphical user interface that includes at least one adjustable interface element for adjusting at least one parameter of the input data and at least one selectable interface element for accepting at least one of the enterprise resource management recommendations.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

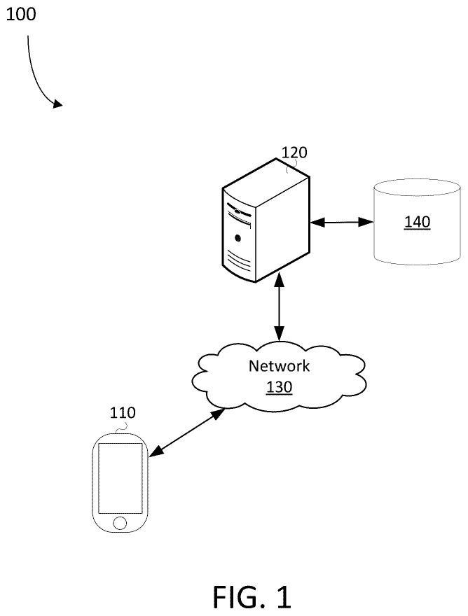

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may be associated with an enterprise and may take a variety of forms including, for example, a mobile communication device such as a smartphone, a tablet computer, a wearable computer (such as a head-mounted display or smartwatch), a laptop or desktop computer, or a computing device of another type. The computing device 110 may store software instructions that cause the computing device 110 to establish communications with the server computer system 120.

The server computer system 120 may include an artificial intelligence engine that may be configured to generate enterprise resource management recommendations. As will be described, the artificial intelligence engine may include an artificial intelligence model stack that hosts a plurality of trained artificial intelligence models.

The server computer system 120 may maintain a database 150 that includes various data records. For example, the server computer system 120 may be a financial institution server which may maintain customer bank accounts. In this example, a data record may, for example, reflect an amount of value stored in a particular account associated with a user. The amount of value may include a quantity of currency

The database 150 may include data records for a plurality of resource accounts and at least some of the data records may define a quantity of resources. For example, the enterprise that is associated with the client device 110 may be associated with one or more resource accounts having one or more data records in the database 150. The data records may reflect a quantity of resources that are available to the enterprise. Such resources may include owned resources and, in at least some embodiments, borrowed resources (e.g., resources available on credit). The quantity of resources that are available to or associated with an enterprise may be reflected by a balance defined in an associated data record such as, for example, a bank balance. The resource accounts may include, for example, a chequing account, a savings account, a borrowing account such as for example a line of credit account, a credit card account, a loyalty point account, etc. As such, at least some of the data records may define a chequing account balance, a savings account balance, a line of credit account balance, a credit card account balance, a loyalty point account balance, etc.

The database 150 may additionally include data records for storing data that may include enterprise profile data, resource usage data, resource pool data, resource contribution data, resource throughput data, market data, feedback data, etc. The data may include historical data and may additionally include data that may be collected in real-time or near real-time.

Enterprise profile data may include data associated with enterprises such as for example industry type, financial health indicators, and resource usage patterns.

Resource usage data may include historical data showing resource usage such as for example resource transaction amounts, peak resource usage times, resource usage patterns.

Resource pool data may include historical data showing past resource pool usage such as for example past product usage and may identify one or more accounts or financial products.

Resource contribution data may include historical data showing past resource contributions such as for example fees associated with resource usage or resource pools.

Resource throughput data may include historical data showing resource throughput from one or more resource pools and this may include, for example, transaction frequency.

Market data may include real-time and historical market data that may reflect trends relevant to enterprise resource recommendations.

Feedback data may include data gathered from interactions with previous recommendations and prices, including acceptance or rejection, adjustments to recommended parameters, and changes in resource usage behavior following recommendations.

At least some of the data stored in the database 150 may be used to generate training data for training artificial intelligence models as will be described in more detail below.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

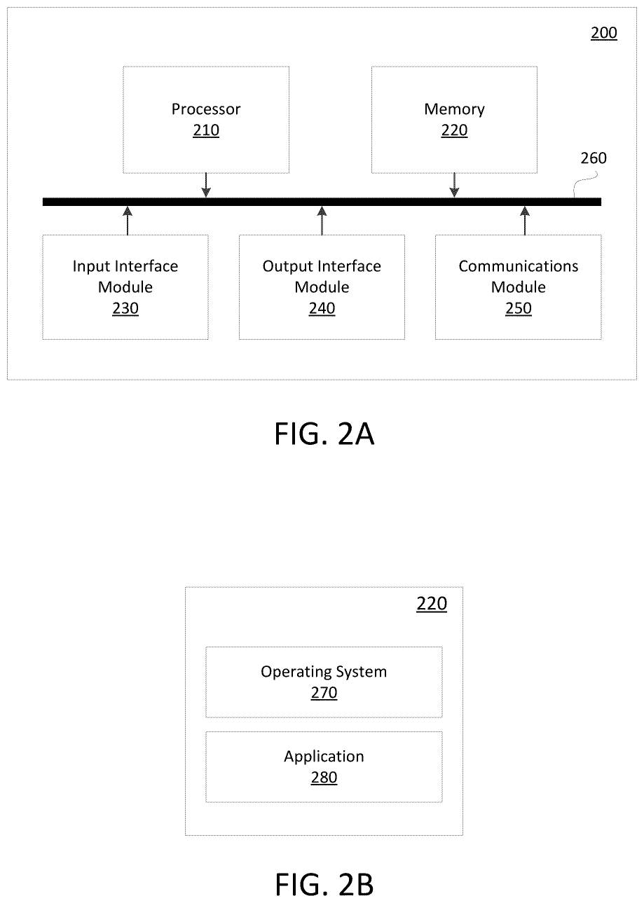

FIG. 2A is a high-level operation diagram of an example computer device 200. In some embodiments, the example computer device 200 may be exemplary of one or more of the computing device 110 and/or the server computer system 120. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi™, using Bluetooth™ or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS™, Google Android™, Linux™, Microsoft Windows™, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations.

For example, in at least some embodiments in which the computer device 200 functions as the client device 110, the applications 280 may include a banking application. The banking application may be configured for secure communications with the server computer system 120 and may provide various banking functions such as, for example, the ability to display a quantum of value in one or more data records (e.g., display balances), configure or request that operations such as transfers of value (e.g., bill payments, email money transfers and other transfers) be performed, and other account management functions. For example, the banking application may be configured to allow a user to submit a request for enterprise resource management recommendations.

By way of further example, in at least some embodiments in which the computer device 200 functions as the client device 110, the applications 280 may include a web browser, which may also be referred to as an Internet browser. In at least some such embodiments, the server computer system 120 may be a web server. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g., display balances), configure or request that operations such as transfers of value (e.g. bill payments and other transfers) be performed, and other account management functions. For example, the banking interface may be configured to allow a user to submit a request for enterprise resource management recommendations.

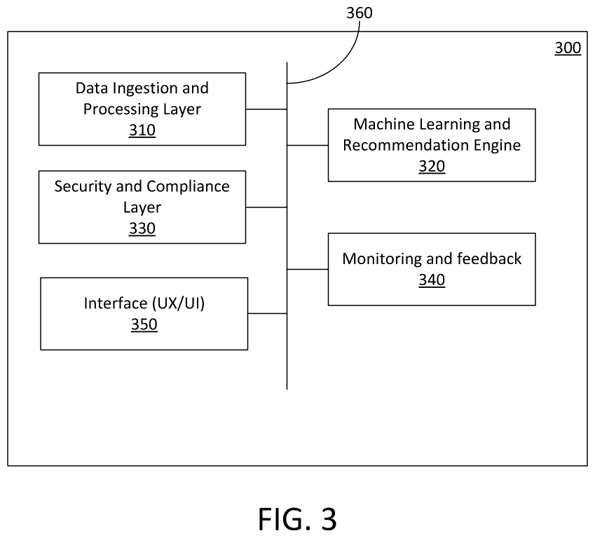

As mentioned, the server computer system 120 may include an artificial intelligence engine that may be configured to generate enterprise resource management recommendations. FIG. 3 is an example schematic diagram outlining various components of an artificial intelligence engine 300. As can be seen, the artificial intelligence engine 300 includes a data ingestion and processing layer 310, a machine learning and recommendation engine 320, a security and compliance layer 330, a monitoring and feedback loop 340, and an interface 350. The various components communicate with one another over a pipeline 360.

The data ingestion and processing layer 310 may ingest data from multiple sources such as for example the database 150 and/or one or more application programming interfaces (APIs). The data ingestion and processing layer 310 may utilize one or more software tools such as for example Apache™ Kafka for handling real-time data. The data ingestion and processing layer 310 may utilize one or more techniques such as for example batch processing for handling non-real-time data and this may be done to optimize resource usage.

The data ingestion and processing layer 310 may perform feature extraction on the ingested data. Features such as for example enterprise profile data, resource usage history, resource consumption data, resource pool data, resource contribution data, resource throughput data, market data, etc. may be extracted. The data ingestion and processing layer 310 may utilize one or more software tools to automate feature extraction and handle complex temporal and relational data structures.

The machine learning and recommendation engine 320 is configured to analyze data to generate specific recommendations based on input data provided thereto. The machine learning and recommendation engine 320 includes an artificial intelligence stack hosting a plurality of trained artificial intelligence models. The artificial intelligence stack may support multiple functions and tasks by leveraging the various models to generate the recommendations.

The trained artificial intelligence models may include a collaborative filtering model, a content-based filtering model, a context-aware filtering model and a dynamic resource contribution module.

The collaborative filtering model is trained to identify similarities between enterprises based on historical resource consumption data. The collaborative filtering model may generate recommendations for resource pool data such as for example products based on similarities between enterprises with similar historical resource consumption data or with similar resource consumption behaviors.

The content-based filtering model is trained to align recommendations with specific attributes of enterprise profile data. The content-based filtering model may generate recommendations for resource pool data such as for example products to match specific attributes of an enterprise.

The context-aware filtering model is trained to adjust recommendations based on real-time context including patterns, location, and current market conditions. The context-aware filtering model may add contextual elements to refine the recommendations.

The dynamic resource contribution module may be configured to adjust resource contribution data based on a set of parameters including enterprise segmentation, historical resource contribution trends. The dynamic resource contribution module may employ reinforcement learning to continuously optimize resource contribution decisions based on response data.

The machine learning and recommendation engine 320 may additionally include explainable AI features that may utilize interpretable models to generate explanations for each recommendation. The explanations may include human-readable rationales for each recommendation presented.

The security and compliance layer 330 may be configured to ensure data protection and regulatory compliance. For example, the security and compliance layer 330 may be configured to encrypt data using one or more known encryption methods and may anonymize any potential customer identifiers using tokenization and/or anonymization. The security and compliance layer 330 may implement automated logging and auditing features to track recommendations generated by the artificial intelligence engine.

In one or more embodiments, the security and compliance layer 330 may utilize federated learning during the training of the artificial intelligence engine and this may ensure the training data is not moved from its source to minimize data-sharing risks and ensure compliance with data sharing regulations. Put another way, the security and compliance layer 330 may enable model training on customer data without transmitting the data outside of secure environments.

The monitoring and feedback loop 340 is configured to collect interaction data such as for example user interaction data. The interaction data may include data associated with recommendations accepted and/or rejected by users. The interaction data may additionally or alternatively include data associated with adjustments made to input data or other types of data that may be provided as input to the artificial intelligence engine or that may be received as output from the artificial intelligence engine.

In one or more embodiments, the monitoring and feedback loop 340 may use the collected data to generate new sets of training or retraining data that may be used to train or retrain one or more of the artificial intelligence models. The training or retraining may include scheduled or triggered model retraining. In one or more embodiments, the monitoring and feedback loop 340 may include an automated retraining pipeline that may integrate the collected data to update the recommendation engine periodically.

In one or more embodiments, the monitoring and feedback loop 340 may integrate the interaction data to adjust the model based on monitored user behavior. By continuously training or retraining the one or more artificial intelligence models, the accuracy of the artificial intelligence engine 300 is improved.

The interface 350 may be configured to generate and present recommendations on a graphical user interface on the computing device 110. The interface 350 may include selectable interface elements that may be used to provide feedback on the recommendations generated by the artificial intelligence engine 300.

In one or more embodiments, the interface 350 may be configured to generate and present recommendations on a graphical user interface to allow a user to view and interact with the recommendations, to adjust at least one parameter of input data, to adjust a particular value associated with a generated recommendation, to review data associated with the recommendations, etc.

The interface 350 may enable users to provide real-time feedback on the recommendations which may be used in real-time to refine the artificial intelligence engine 300.

The interface 350 may include an interactive interface that may present adjustable parameters such as for example resource usage data, resource pool data, resource contribution data, resource throughput data, etc. that may allow an enterprise to dynamically view corresponding adjustments based on the modified parameters. The interactive interface may display a recommended resource contribution based on the selected parameters and may allow or enable an enterprise to adjust the recommended resource contribution within predefined limits. The predefined limits may be associated with regulatory or financial institution defined guidelines to ensure compliance.

In one or more embodiments, the interactive interface may include a parameter sensitivity analysis feature that may provide real-time visualizations showing the impact each adjustable parameter has on the recommended resource contribution.

In one or more embodiments, the interactive interface may include one or more selectable interface elements allowing or enabling an enterprise to save and compare multiple recommendations based on different parameters.

Through use of the interactive interface, the artificial intelligence engine allows dynamic adjustments to be made to one or more parameters of the input data and as such the artificial intelligence engine has improved relevance and accuracy.

As mentioned, the machine learning and recommendation engine 320 includes an artificial intelligence stack hosting a plurality of trained artificial intelligence models. The training of the artificial intelligence models will now be described.

Training data is obtained from one or more sources such as for example the database 150. The training data may include enterprise profile data, resource usage data, resource pool data, resource contribution data, resource throughput data, market data, feedback data, etc. Enterprise profile data may include data associated with enterprises such as for example industry type, financial health indicators, and resource usage patterns. Resource usage data may include historical data showing resource usage such as for example resource transaction amounts, peak resource usage times, resource usage patterns. Resource pool data may include historical data showing past resource pool usage such as for example past product usage and may identify one or more accounts or financial products. Resource contribution data may include historical data showing past resource contributions such as for example fees associated with resource usage or resource pools. Resource throughput data may include historical data showing resource throughput from one or more resource pools and this may include, for example, transaction frequency. Market data may include real-time and historical market data that may reflect trends relevant to enterprise resource recommendations. Feedback data may include data gathered from interactions with previous recommendations and prices, including acceptance or rejection, adjustments to recommended parameters, and changes in resource usage behavior following recommendations.

The training data is pre-processed to remove noisy or irrelevant data points and this may be done to ensure data integrity and to handle missing values.

Feature extraction is then performed on the pre-processed training data and one or more features are created.

In one or more embodiments, the features may include enterprise-specific resource usage metrics that include average resource usage (such as for example average transaction amount), peak resource usage hours, etc.

In one or more embodiments, the features may include market indicators for contextual resource contribution adjustments.

In one or more embodiments, the features may include temporal patterns such as for example resource throughput patterns.

In one or more embodiments, the features may include response rates to previous recommendations and changes in resource usage behavior following recommendations.

The features may additionally include enterprise profile features such as for example industry classification, enterprise size, enterprise age, geographic location, etc.

The features may additionally include financial health and performance features such as for example revenue trends, profit margins, debt ratios, cash flow patterns, credit score. The features may additionally include behavioral and interaction data such as for example past financial product usage, transaction history, website or app engagement, customer support interactions, etc. The features may additionally include product specific data such as for example loan amounts and terms, interest rate sensitivity, preferred payment methods, investment and risk preferences, etc. The features may additionally include external market data such as for example industry trends and economic indicators. The features may additionally include demographic and psychographic data such as for example decision-maker demographics, business values and mission, etc. The features may be created as time-based features, aggregated or derived metrics, interaction rations, etc.

Normalization and encoding methods may be utilized to improve model performance and encode categorical data using one-hot coding or other embedding techniques.

As mentioned, the trained artificial intelligence models may include a collaborative filtering model, a content-based filtering model, a context-aware filtering model and a dynamic resource contribution module. As such, an ensemble approach using multiple AI models may be used to train the artificial intelligence models.

In one or more embodiments, the collaborative filtering model may be trained using a matrix factorization algorithm such as for example Deep Neural Networks (DNN) to learn similarities between the enterprises'past interactions with resource pools such as past product interactions and utilizations. In this manner, the collaborative filtering model may be trained to generate recommendations for resource pool data such as for example products based on similarities between enterprises with similar historical resource consumption data or with similar resource consumption behaviors

In one or more embodiments, the content-based filtering model may be trained using Gradient Boosting or Random Forests to recommend products based on enterprise attributes, resource usage patterns, and behavioral data. In this manner, the content-based filtering model may be trained to generate recommendations for resource pool data such as for example products to match specific attributes of an enterprise.

In one or more embodiments, the context-aware filtering model may be trained using Recurrent Neural Networks (RNN) to capture temporal dependencies in enterprise behaviors and market trends. In this manner, the context-aware filtering model may be trained to adjust recommendations based on real-time context.

The dynamic resource contribution module may be trained using one or more algorithms. For example, the dynamic resource contribution module may be trained using Supervised Machine Learning based on historical resource usage data to set baseline dynamic resource contribution values for each enterprise segment. Gradient Boosting Machines (GBM) or Random Forests may be utilized to handle complex feature interactions.

The dynamic resource contribution module may additionally be trained using Reinforcement Learning. For example, the dynamic resource contribution module may learn optimal resource contribution adjustments by simulating enterprise responses and optimizing resource contributions over time. Specifically, enterprise attributes, resource usage volume, enterprise feedback on past resource contribution data, and market conditions may be encoded. The resource contribution may be adjusted up or down within a predefined range based on responses.

The explainable AI features may be trained at least by implementing interpretable layers using Shapley Additive exPlanations (SHAP) to provide explanations for each recommendation and resource contribution decision.

The training of the artificial intelligence modules may include splitting the training data into training and validation datasets. A training pipeline may be utilized to automate data preprocessing, model training, and validation. In one or more embodiments, hyperparameter tuning may be utilized to select optimal hyperparameters for each model component.

In manners described herein, the architecture of the artificial intelligence engine 300 ensures high scalability, continuous adaptability that may enable or otherwise allow enterprises to visualize how adjusting parameters may affect resource contributions. The combination of collaborative, content-based, and context-based filtering increases the precision of the recommendations. Further, the use of reinforcement learning on the dynamic resource contribution module serves to optimize resource contribution in real-time.

The artificial intelligence engine 300 integrates multiple artificial intelligence techniques to generate personalized, real-time enterprise resource recommendations. The artificial intelligence engine 300 enables enterprises to adjust one or more parameters of input data interactively, creating a feedback-driven model that responds dynamically to enterprise behavior.

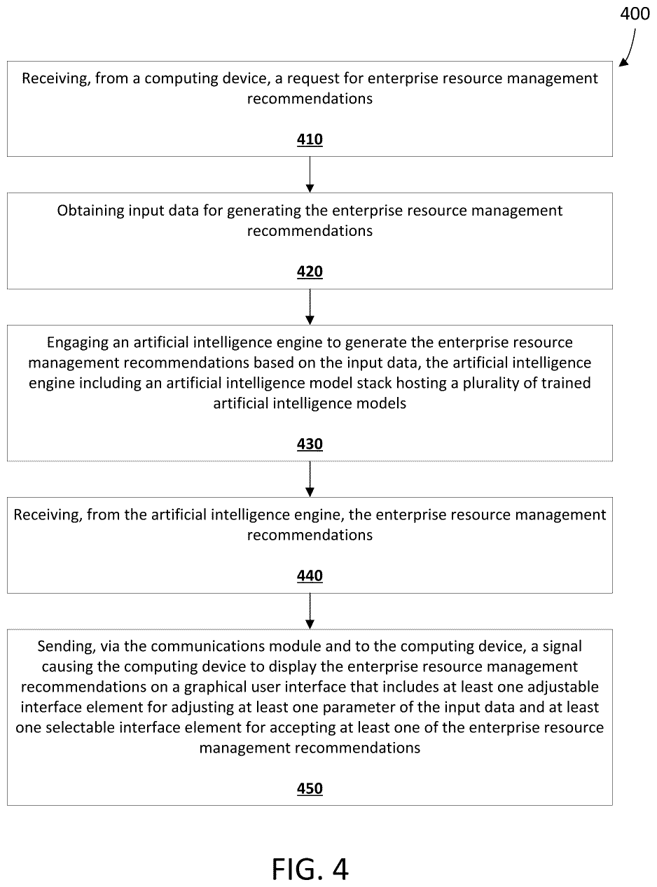

The server computer system 120 may engage the artificial intelligence engine to generate enterprise resource management recommendations. Reference is made to FIG. 4, which illustrates, in flowchart form, a method 400 for generating enterprise resource management recommendations. The method 400 may be implemented by a computing device having suitable processor-executable instructions for causing the computing device to carry out the described operations. The method 400 may be implemented, in whole or in part, by the server computer system 120.

The method 400 includes receiving, from a computing device, a request for enterprise resource management recommendations (step 410).

In one or more embodiments, the server computer system 120 may cause the computing device 110 to display a graphical user interface that includes a selectable interface element for submitting a request for enterprise resource management recommendations. For example, the server computer system 120 may provide a mobile application that may be downloaded and accessed on the computing device 110. Within the mobile application, a graphical user interface may be displayed that includes the selectable interface element. As another example, the server computer system 120 may include a web server that may host or otherwise maintain a website that may present a mobile banking interface that includes the selectable interface element.

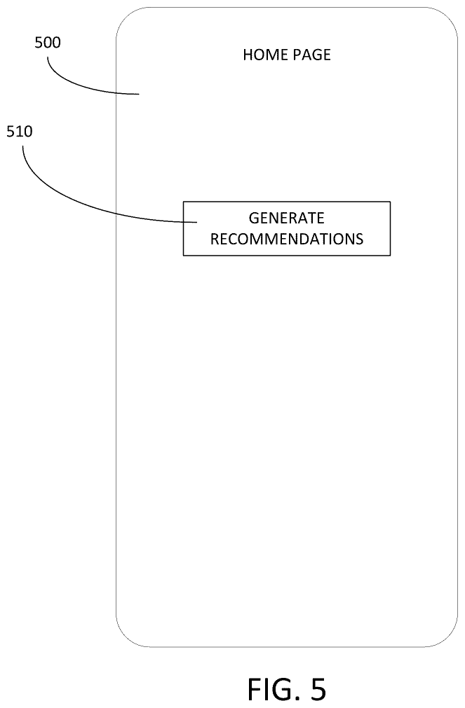

An example graphical user interface 500 is shown in FIG. 5. As can be seen, the graphical user interface 500 is presented that includes a selectable interface element 510 for submitting a request for enterprise resource management recommendations.

A user operating the computing device 110 may select the selectable interface element 510 for submitting a request for enterprise resource management recommendations by performing, for example, a tap gesture on a display screen of the computing device 110 at a location that corresponds to a location of the selectable interface element 510 or may perform a mouse-click on the selectable interface element 510. In response, the computing device 110 may send a signal to the server computer system 120 that includes the request for enterprise resource management recommendations.

The method 400 includes obtaining input data for generating the enterprise resource management recommendations (step 420).

The server computer system 120 obtained input data for generating the enterprise resource management recommendations.

In one or more embodiments, the server computer system 120 may obtain at least some of the data from the database 150. For example, the server computer system 120 may identify an account associated with an enterprise based on, for example, authentication information such as a username and a password that was provided when logging into the account. The input data may be retrieved from the database 150 based on the identified account.

In one or more embodiments, the server computer system 120 may obtain at least some of the data using one or more application programming interfaces (APIs). For example, the server computer system 120 may integrate with one or more third party servers in an open banking framework. In this example, a third party financial institution may offer data such as for example resource usage data and/or resource pool data to the server computer system 120 via a secure API. By leveraging open banking protocols, the server computer system 120 may access and consolidate account data from multiple sources to obtain the input data. The server computer system 120 may require permission to access the data and this may be done within the open banking framework such as for example by requesting that the enterprise grant permission to the server computer system 120.

In one or more embodiments, the server computer system 120 may analyze the obtained input data and may determine that additional data may be required. In these embodiments, the server computer system 120 may prompt the user of the computing device 110 to provide the additional data and this may be done, for example, by presenting one or more questions or prompts on a display screen of the computing device 110.

In one or more embodiments, the input data may include at least one of enterprise profile data, resource usage data, resource pool data, resource contribution data, resource throughput data, and feedback data. In one or more embodiments, the input data may be related to enterprise banking and/or enterprise banking products and as such the input data may specifically include at least one of banking products currently owned or used by the enterprise, banking fees currently paid by the enterprise, transaction history, transaction frequency, and other historical banking data relating to enterprise banking.

The method 400 includes engaging an artificial intelligence engine to generate the enterprise resource management recommendations based on the input data, the artificial intelligence engine including an artificial intelligence model stack hosting a plurality of trained artificial intelligence models (step 430).

The server computer system 120 may engage the artificial intelligence engine to generate the enterprise resource management recommendations. The artificial intelligence engine may include the artificial intelligence engine 300 described herein.

The input data is provided to the artificial intelligence engine to generate the enterprise resource management recommendations. In one or more embodiments, one or more parameters of the input data may be determined by the artificial intelligence engine. For example, the artificial intelligence engine, specifically, the data ingestion and processing layer, may analyze the input data to determine or calculate one or more parameters such as for example resource throughput data and/or resource usage data and this may be done using feature extraction.

The artificial intelligence engine generates the enterprise resource management recommendations based on the input data using the trained artificial intelligence models. The recommendations may include recommendations at least for one or more resource pools and an associated resource contribution.

In one or more embodiments, where the input data is related to enterprise banking and/or enterprise banking products, the recommendations may include recommendations for enterprise banking products and/or services and fees associated therewith.

As mentioned, the machine learning and recommendation engine may include explainable AI features that may utilize interpretable models to generate explanations for each recommendation. The explanations may include human-readable rationales for each recommendation presented. As such, the recommendations may include explanations for each recommendation.

The method 400 includes receiving, from the artificial intelligence engine, the enterprise resource management recommendations (step 440).

The server computer system 120 receives, from the artificial intelligence engine, the enterprise resource management recommendations.

The method 400 includes sending, to the computing device, a signal causing the computing device to display the enterprise resource management recommendations on a graphical user interface that includes at least one adjustable interface element for adjusting at least one parameter of the input data and at least one selectable interface element for accepting at least one of the enterprise resource management recommendations (step 450).

The server computer system 120 sends a signal that causes the computing device 110 to display the enterprise resource management recommendations on a graphical user interface.

In one or more embodiments, the displayed recommendations may identify one or more resource pools and associated resource contributions. The displayed recommendations may additionally include the explanations for each recommendation and this may be based on the explanations generated by the machine learning and recommendation engine.

The graphical user interface includes at least one adjustable interface element for adjusting at least one parameter of the input data.

In one or more embodiments, the at least one parameter of the input data may include at least one parameter determined or otherwise extracted by the artificial intelligence engine. For example, as mentioned, at least one parameter of the input data may be determined by the data ingestion and processing layer of the artificial intelligence engine. The at least one parameter may include at least one feature extracted by the artificial intelligence engine.

In one or more embodiments, the at least one parameter of the input data may include resource throughput data and/or resource usage data. In embodiments where the input data is related to enterprise banking, the resource throughput data may include transaction frequency and resource usage data may include an average transaction amount.

In one or more embodiments, the at least one adjustable interface element for adjusting at least one parameter of the input data may be set to a default value based on a value determined by the artificial intelligence engine 300. For example, the artificial intelligence engine 300 may analyze the input data and may extract a feature that includes transaction frequency. The artificial intelligence engine may determine or calculate a transaction frequency of one hundred (100) transactions per day. As such, the at least one adjustable interface element may be set to a value of one hundred (100) and this may be displayed on the graphical user interface. As will be described, the user may adjust the at least one adjustable interface element to a higher or lower value and in response, the artificial intelligence engine may generate updated recommendations based on the new value. Notably, the artificial intelligence engine will not have to re-generate the at least one parameter using feature extraction as the value has now been set by the user. Put another way, adjustments made to the at least one parameter of the input data using the at least one adjustable interface element eliminates the requirement of having to re-perform feature extraction and increases efficiency of the artificial intelligence model.

The graphical user interface includes at least one selectable interface element for accepting at least one of the enterprise resource management recommendations. In one or more embodiments, each selectable interface element may be associated with a particular recommendation.

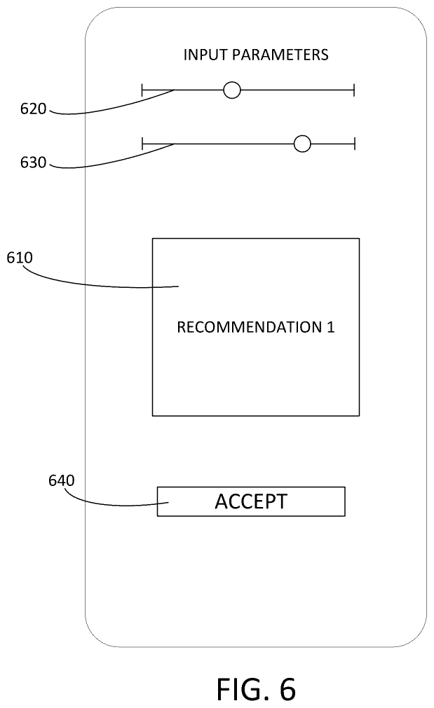

An example graphical user interface 600 is shown in FIG. 6. As can be seen, the graphical user interface 600 displays an enterprise resource management recommendation 610. The enterprise resource management recommendation 610 may include a recommendation for one or more resource pools such as for example one or more products for managing or maintaining resources. The enterprise resource management recommendation 610 may include an explanation for the recommendation based on an explanation generated by the machine learning and recommendation engine.

The graphical user interface 600 included a first adjustable interface element 620 for adjusting a first parameter associated with the input data and a second adjustable interface element 630 for adjusting a second parameter associated with the input data. The first adjustable interface element 620 and the second adjustable interface element 630 are in the form of a slider and may be adjusted by the user performing, for example, a drag-and-drop gesture or a tap gesture on a display screen of the computing device 110. The first adjustable interface element 620 and the second adjustable interface element 630 may be moved between a minimum and a maximum value and this may be defined by the artificial intelligence engine based on the parameter associated therewith. In one or more embodiments, the minimum and the maximum value may be determined by the security and compliance layer 330 based on one or more regulations. The graphical user interface 600 includes a selectable interface element 640 for accepting the recommendation.

The user may adjust the adjustable interface elements to adjust at least one parameter of the input data and in response the server computer system 120 may perform operations to obtain updated enterprise resource management recommendations.

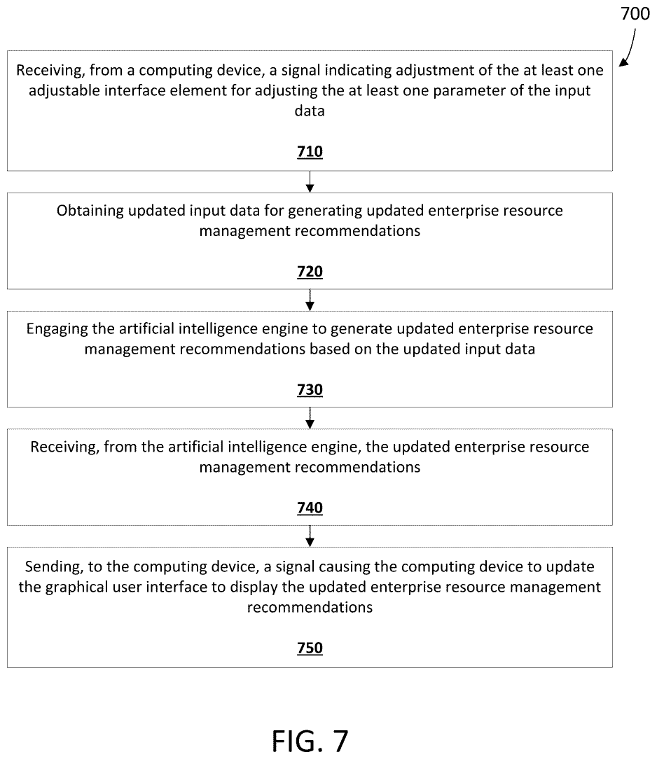

Reference is made to FIG. 7, which illustrates, in flowchart form, a method 700 for generating updated enterprise resource management recommendations. The method 700 may be implemented by a computing device having suitable processor-executable instructions for causing the computing device to carry out the described operations. The method 700 may be implemented, in whole or in part, by the server computer system 120.

The method 700 includes receiving, from the computing device, a signal indicating adjustment of the at least one adjustable interface element for adjusting the at least one parameter of the input data (step 710).

In response to adjustment of the at least one adjustable interface element, the computing device 110 may send a signal indicating the adjustment of the at least one adjustable interface element for adjusting the at least one parameter of the input data. The server computer system 120 receives this signal.

The method 700 includes obtaining updated input data for generating updated enterprise resource management recommendations based on the adjustment of the at least one adjustable interface element (step 720).

The server computer system 120 may analyze the signal to identify the adjustable interface element that has been adjusted and to determine what position the adjustable interface element has been moved to. The server computer system may obtain the updated input data based on the position of the adjustable interface element.

In one or more embodiments, the at least one parameter associated with the adjustable interface element may have been determined or calculated using feature extraction. As such, the server computer system 120 may send the at least one parameter to the artificial intelligence engine and this may reduce or otherwise eliminate the requirement of the artificial intelligence engine to perform additional feature extraction. Put another way, the artificial intelligence engine may map the adjustable interface element to the extracted at least one parameter of the input data and may automatically update the at least one parameter of the input data in response to adjustment of the adjustable interface element.

The method 700 includes engaging the artificial intelligence engine to generate updated enterprise resource management recommendations based on the updated input data (step 730).

The server computer system 120 may engage the artificial intelligence engine to generate updated enterprise resource management recommendations based on the updated input data and this may be done in a manner similar to that described herein.

The method 700 includes receiving, from the artificial intelligence engine, the updated enterprise resource management recommendations (step 740).

The artificial intelligence engine generates updated enterprise resource management recommendations in manners similar to that described herein and sends the recommendations to the server computer system 120.

The method 700 includes sending, to the computing device, a signal causing the computing device to update the graphical user interface to display the updated enterprise resource management recommendations (step 750).

The server computer system 120 performs operations to update the graphical user interface to display the updated enterprise resource management recommendations.

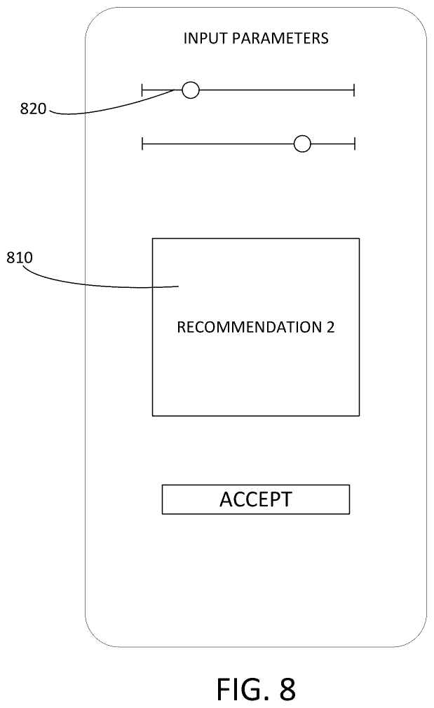

An example updated graphical user interface 800 is shown in FIG. 8. The updated graphical user interface 800 may be based on the graphical user interface 600. For example, the user may adjust the first adjustable interface element 620 (FIG. 6) to adjust the first parameter of the input data and this may be indicated by the position of the first adjustable interface element 820 shown in FIG. 8. The server computer system 120 may perform the operations of the method 700 to generate updated enterprise resource management recommendations and to update the graphical user interface to display the updated enterprise resource management recommendations 810.

In one or more embodiments, the enterprise resource management recommendations may include at least one recommendation for a resource pool based on resource throughput extracted from the input data. In these embodiments, the at least one recommendation may define a resource contribution for the recommended resource pool and the graphical user interface may display the resource contribution for the resource pool and may include at least one adjustable interface element for adjusting the resource contribution to a particular value. The at least one recommendation may be an output of the artificial intelligence engine and may be based on the input data.

In one or more embodiments, the graphical user interface may include at least one adjustable interface element for adjusting at least one value associated with the enterprise resource management recommendations.

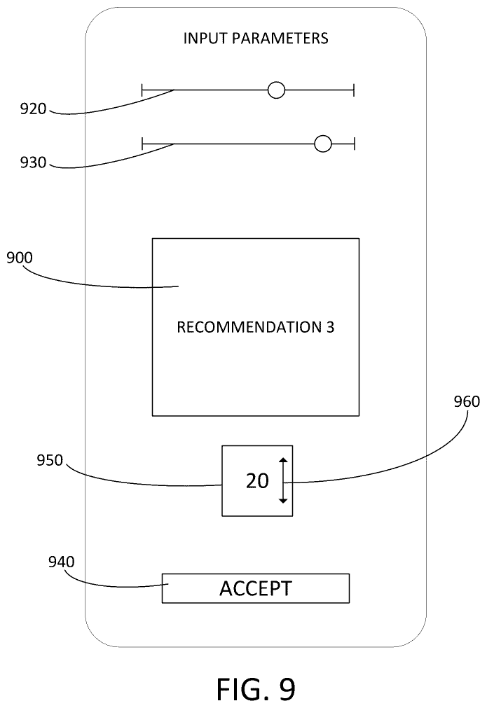

An example graphical user interface 900 is shown in FIG. 9. The graphical user interface 900 is similar to the graphical user interface 600 and similarly displays the enterprise resource management recommendation 910 and includes a first adjustable interface element 920 for adjusting a first parameter associated with the input data and a second adjustable interface element 930 for adjusting a second parameter associated with the input data and a selectable interface element 940 for accepting the recommendation. The graphical user interface 900 also displays a resource contribution 950 associated with the enterprise resource management recommendation and an adjustable interface element 960 for adjusting the resource contribution to a particular value.

The user may adjust the resource contribution to a particular value using the adjustable interface element 960. For example, the user may perform a tap gesture on an “up arrow” of the adjustable interface element 960 to increase the resource contribution and may perform a tap gesture on a “down arrow” of the adjustable interface element 960 to decrease the resource contribution. Adjustment of the resource contribution to a particular value may indicate that the user may want to see what parameters of input data are required to achieve the particular value. As such, in response to adjustment of the resource contribution, the server computer system 120 may perform operations to update the graphical user interface to display at least one parameter of the input data that is to be modified to achieve the resource contribution.

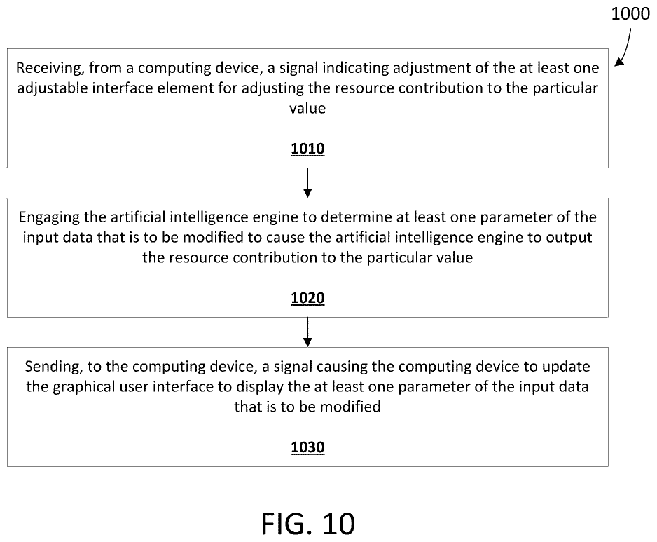

Reference is made to FIG. 10, which illustrates, in flowchart form, a method 1000 for updating the graphical user interface to display at least one parameter of the input data that is to be modified to achieve the resource contribution. The method 1000 may be implemented by a computing device having suitable processor-executable instructions for causing the computing device to carry out the described operations. The method 1000 may be implemented, in whole or in part, by the server computer system 120.

The method 1000 includes receiving, from the computing device, a signal indicating adjustment of the at least one adjustable interface element for adjusting the resource contribution to the particular value (step 1010).

In response to adjustment of the at least one adjustable interface element for adjusting the resource contribution to the particular value, the computing device 110 may send the signal indicating adjustment of the at least one adjustable interface element for adjusting the resource contribution to the particular value. The signal may include an indication of the particular value.

The method 1000 includes engaging the artificial intelligence engine to determine at least one parameter of the input data that is to be modified to cause the artificial intelligence engine to output the resource contribution to the particular value (step 1020).

The server computer system 120 provides the particular value to the artificial intelligence engine together with a request to determine at least one parameter of the input data that is to be modified to cause the artificial intelligence engine to output the resource contribution to the particular value. The artificial intelligence engine may utilize the particular value to reverse-engineer the recommendation and to identify one or more parameters of the input data that need to be modified to result in the particular value of resource contribution. For example, as mentioned, adjustment of the resource contribution to a particular value may indicate that the user may want to see what parameters of input data are required to achieve the particular value.

The method 1000 includes sending, to the computing device, a signal causing the computing device to update the graphical user interface to display the at least one parameter of the input data that is to be modified (step 1030).

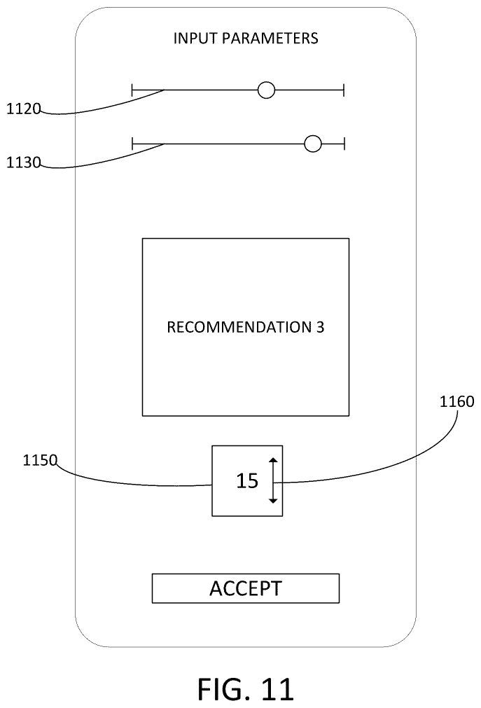

The server computer system 120 receives the at least one parameter of input data that is required to achieve the particular value of resource contribution and updates the graphical user interface accordingly. An example updated graphical user interface 1100 is shown in FIG. 11. The updated graphical user interface 1100 may be based on the graphical user interface 900 (FIG. 9). As can be seen, the user has adjusted the resource contribution from a value of 20 (FIG. 9) to a value of 15 (shown as resource contribution 1150 in FIG. 11). The graphical user interface 1100 is updated to adjust the first adjustable interface element 1120 and the second adjustable interface element 1130 to indicate the value of the first parameter and the second parameter of the input data that are required to achieve the particular resource contribution value.

The user may accept one or more of the enterprise resource management recommendations and in response the server computer system 120 may perform operations to retrain at least one of the trained artificial intelligence models.

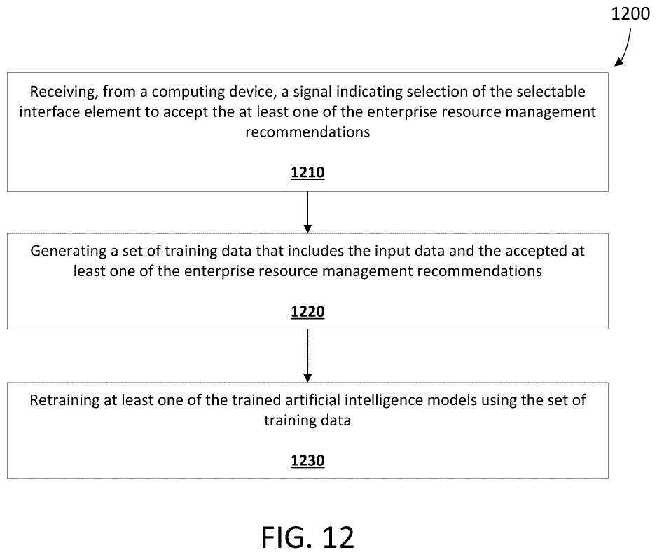

Reference is made to FIG. 12, which illustrates, in flowchart form, a method 1200 for retraining at least one of the trained artificial intelligence models. The method 1200 may be implemented by a computing device having suitable processor-executable instructions for causing the computing device to carry out the described operations. The method 1200 may be implemented, in whole or in part, by the server computer system 120.

The method 1200 includes receiving, from the computing device, a signal indicating selection of the selectable interface element to accept the at least one of the enterprise resource management recommendations (step 1210).

The user may select the selectable interface element to accept the at least one of the enterprise resource management recommendations by performing, for example, a tap gesture on a display screen of the computing device 110 at a location corresponding to the location of the selectable interface element. In response, the computing device 110 may send the signal to the server computer system 120.

The method 1200 includes generating a set of training data that includes the input data and the accepted at least one of the enterprise resource management recommendations (step 1220).

The server computer system 120 may generate training data that includes the input data and the accepted at least one of the enterprise resource management recommendations. For example, the training data may include the one or more parameters of the input data defined by the user using the adjustable interface elements and may include, for example, the resource contribution agreed to or accepted by the user.

In one or more embodiments, the server computer system 120 may engage the artificial intelligence engine, specifically the monitoring and feedback loop, to generate the training data.

The method 1200 includes retraining at least one of the trained artificial intelligence models using the set of training data (step 1230).

The training data may be used to retrain the at least one of the trained artificial intelligence models in manners similar described to that herein. The retraining may include scheduled or triggered model retraining.

In addition to retraining the at least one of the trained artificial, the server computer system 120 may perform operations based on the accepted recommendation. For example, the recommendation may include a recommendation for one or more financial products offered by the server computer system 120 and as such the server computer system 120 may perform operations to open the one or more financial products and this may include opening one or more accounts. As another example, the recommendation may include a recommendation to create or modify a data record within the database and as such, in response to accepting the recommendation, the server computer system 120 may perform operations to create or modify the data record.

In one or more embodiments described herein, the graphical user interface may display multiple recommendations and/or may include one or more selectable interface elements for switching between or toggling between two or more recommendations.

Through use of the adjustable interface elements, the artificial intelligence engine described herein allows dynamic adjustments to be made to one or more parameters of the input data and as such the artificial intelligence engine has improved relevance and accuracy.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A server computer system comprising:
a communications module;
at least one processor coupled with the communications module; and
a memory coupled to the at least one processor and storing processor-executable instructions which, when executed by the at least one processor, configure the at least one processor to:
receive, via the communications module and from a computing device, a request for enterprise resource management recommendations;
obtain input data for generating the enterprise resource management recommendations;
engage an artificial intelligence engine to generate the enterprise resource management recommendations based on the input data, the artificial intelligence engine including an artificial intelligence model stack hosting a plurality of trained artificial intelligence models;
receive, from the artificial intelligence engine, the enterprise resource management recommendations; and
send, via the communications module and to the computing device, a signal causing the computing device to display the enterprise resource management recommendations on a graphical user interface that includes at least one adjustable interface element for adjusting at least one parameter of the input data and at least one selectable interface element for accepting at least one of the enterprise resource management recommendations.

2. The server computer system of claim 1, wherein the processor-executable instructions, when executed, further configure the at least one processor to:
receive, via the communications module and from the computing device, a signal indicating adjustment of the at least one adjustable interface element for adjusting the at least one parameter of the input data;
obtain updated input data for generating updated enterprise resource management recommendations based on the adjustment of the at least one adjustable interface element;
engage the artificial intelligence engine to generate updated enterprise resource management recommendations based on the updated input data;
receive, from the artificial intelligence engine, the updated enterprise resource management recommendations; and
send, via the communications module and to the computing device, a signal causing the computing device to update the graphical user interface to display the updated enterprise resource management recommendations.

3. The server computer system of claim 1, wherein the enterprise resource management recommendations include at least one recommendation for a resource pool based on resource throughput extracted from the input data.

4. The server computer system of claim 3, wherein the at least one recommendation for the resource pool defines a resource contribution for the resource pool.

5. The server computer system of claim 4, wherein the graphical user interface displays the resource contribution for the resource pool and includes at least one adjustable interface element for adjusting the resource contribution to a particular value.

6. The server computer system of claim 5, wherein the processor-executable instructions, when executed, further configure the at least one processor to:
receive, via the communications module and from the computing device, a signal indicating adjustment of the at least one adjustable interface element for adjusting the resource contribution to the particular value;
engage the artificial intelligence engine to determine at least one parameter of the input data that is to be modified to cause the artificial intelligence engine to output the resource contribution to the particular value; and
send, via the communications module and to the computing device, a signal causing the computing device to update the graphical user interface to display the at least one parameter of the input data that is to be modified.

7. The server computer system of claim 1, wherein the processor-executable instructions, when executed, further configure the at least one processor to:
receive, via the communications module and from the computing device, a signal indicating selection of the selectable interface element to accept the at least one of the enterprise resource management recommendations;
generate a set of training data that includes the input data and the accepted at least one of the enterprise resource management recommendations; and
retrain at least one of the trained artificial intelligence models using the set of training data.

8. The server computer system of claim 1, wherein the input data is retrieved from at least one of a database or an application programming interface (API) based at least on an identity of an enterprise.

9. The server computer system of claim 1, wherein the plurality of trained artificial intelligence models employ a combination of collaborative filtering and reinforcement learning techniques.

10. The server computer system of claim 1, wherein the plurality of trained artificial intelligence models are trained using training data that includes at least enterprise profile data, resource usage data, resource pool data, resource contribution data, resource throughput data, and feedback data.

11. A computer-implemented method comprising:
receiving, via a communications module and from a computing device, a request for enterprise resource management recommendations;
obtaining input data for generating the enterprise resource management recommendations;
engaging an artificial intelligence engine to generate the enterprise resource management recommendations based on the input data, the artificial intelligence engine including an artificial intelligence model stack hosting a plurality of trained artificial intelligence models;
receiving, from the artificial intelligence engine, the enterprise resource management recommendations; and
sending, via the communications module and to the computing device, a signal causing the computing device to display the enterprise resource management recommendations on a graphical user interface that includes at least one adjustable interface element for adjusting at least one parameter of the input data and at least one selectable interface element for accepting at least one of the enterprise resource management recommendations.

12. The computer-implemented method of claim 11, further comprising:
receiving, via the communications module and from the computing device, a signal indicating adjustment of the at least one adjustable interface element for adjusting the at least one parameter of the input data;
obtaining updated input data for generating updated enterprise resource management recommendations based on the adjustment of the at least one adjustable interface element;
engaging the artificial intelligence engine to generate updated enterprise resource management recommendations based on the updated input data;
receiving, from the artificial intelligence engine, the updated enterprise resource management recommendations; and
sending, via the communications module and to the computing device, a signal causing the computing device to update the graphical user interface to display the updated enterprise resource management recommendations.

13. The computer-implemented method of claim 11, wherein the enterprise resource management recommendations include at least one recommendation for a resource pool based on resource throughput extracted from the input data.

14. The computer-implemented method of claim 13, wherein the at least one recommendation for the resource pool defines a resource contribution for the resource pool.

15. The computer-implemented method of claim 14, wherein the graphical user interface displays the resource contribution for the resource pool and includes at least one adjustable interface element for adjusting the resource contribution to a particular value.

16. The computer-implemented method of claim 15, further comprising:
receiving, via the communications module and from the computing device, a signal indicating adjustment of the at least one adjustable interface element for adjusting the resource contribution to the particular value;
engaging the artificial intelligence engine to determine at least one parameter of the input data that is to be modified to cause the artificial intelligence engine to output the resource contribution to the particular value; and
sending, via the communications module and to the computing device, a signal causing the computing device to update the graphical user interface to display the at least one parameter of the input data that is to be modified.

17. The computer-implemented method of claim 11, further comprising:
receiving, via the communications module and from the computing device, a signal indicating selection of the selectable interface element to accept the at least one of the enterprise resource management recommendations;
generating a set of training data that includes the input data and the accepted at least one of the enterprise resource management recommendations; and
retraining at least one of the trained artificial intelligence models using the set of training data.

18. The computer-implemented method of claim 11, wherein the input data is retrieved from at least one of a database or an application programming interface (API) based at least on an identity of an enterprise.

19. The computer-implemented method of claim 11, wherein the plurality of trained artificial intelligence models employ a combination of collaborative filtering and reinforcement learning techniques.

20. A non-transitory computer readable storage medium comprising computer-executable instructions which, when executed, configure a processor to:
receive, via a communications module and from a computing device, a request for enterprise resource management recommendations;
obtain input data for generating the enterprise resource management recommendations;
engage an artificial intelligence engine to generate the enterprise resource management recommendations based on the input data, the artificial intelligence engine including an artificial intelligence model stack hosting a plurality of trained artificial intelligence models;
receive, from the artificial intelligence engine, the enterprise resource management recommendations; and
send, via the communications module and to the computing device, a signal causing the computing device to display the enterprise resource management recommendations on a graphical user interface that includes at least one adjustable interface element for adjusting at least one parameter of the input data and at least one selectable interface element for accepting at least one of the enterprise resource management recommendations.
